(19) United States
(12) Patent Application Publication
(10) Pub. No.: US 2007/0124193 A1
(43) Pub. Date: May 31, 2007

(54) Configuration of a control center in a risk detection system

(75) Inventor: Markus Schuette, Wiler (CH)

Correspondence Address: STAAS & HALSEY LLP, SUITE 700, 1201 NEW YORK AVENUE, N.W., WASHINGTON, DC, 20005, US

(73) Assignee: Siemens Schweiz AG, Zurich (CH)

(21) Appl. No.: 11/518,987

(22) Filed: Sep. 12, 2006

(30) Foreign Application Priority Data
Sep. 12, 2005 (EP) EP05108348

(51) Int. Cl. G06Q 99/00; G07G 1/00

(52) U.S. Cl. 705/10; 705/1

(57) ABSTRACT

A first data set containing at least one first item of configuration information is created as a function of at least one first rule. Then, a second data set containing at least one second item of configuration information is created as a function of the first data set and with at least one second rule. Next, a configuration data set containing at least a third item of configuration information is created as a function of the second data set and at least one third rule, the configuration data set being used to configure a control center in a risk detection system.

### CROSS REFERENCE TO RELATED APPLICATIONS

This application is based on and hereby claims priority to European Application No. EP05108348 filed on Sep. 12, 2005, the contents of which are hereby incorporated by reference.

### BACKGROUND

A method and a system are described for configuring a control center in a risk detection system with a configuration data set containing at least one item of configuration information.

Risk detection systems, such as for instance detection systems for fire, gas, temperature etc. mostly include detectors which are connected to a control center. Such risk detection systems are used in public buildings, office blocks, hotels, industrial buildings, airports, stations, workshops, schools etc. If an alarm is triggered on one of the detectors, the control center is notified. The functions of the control center can be freely parameterized and support an alarm organization adjusted to the object to be monitored. Such control centers mostly exhibit an integrated control element with a graphical display and interfaces to communication networks. Such a control center must be set up and/or configured prior to start-up. The language to be used, the national standards and specifications, the detectors used, the quantity and the parameterization of the detectors, the risk detection control center are hereby configured and/or adjusted. So far a separate configuration has been created for each risk detection control center and this must be adjusted to customer wishes. A plurality of different configurations of a risk detection system can thus exist, which must naturally be attended to individually. If a standard is changed for instance in a country, a change must be made in all of the configuration versions.

### SUMMARY

An aspect is to provide an efficient and cost-effective method and system for configuring a risk detection system.

A core feature is creating a first data set containing at least one first item of configuration information for configuring a risk detection system as a function of at least one first rule. For instance, a data set for risk detection systems for a region of the world, in other words a data set in each instance for Asia, America, Africa, Europe etc could be created for instance. Such a classification is naturally discretionary and can occur arbitrarily, depending on requirements. Subsequently a second data set is created for instance for a country from the region as a function of the first data set and as a function of at least one second rule. The information to be configured is ideally restricted during the creation of the second data set, so that the second data set represents a subset of the first data set, which is adjusted to the national standards and specifications, the national language, the relevant risk detection control center etc. by the at least one second rule. As a function of this second data set, a configuration data set containing at least one item of configuration information is created for the relevant risk detection control center. At least one third rule is used here during the creation of the configuration data set. Device-specific and customer-specific demands can be considered for instance. The configuration data set is finally used to configure the relevant risk detection control center.

With the aid of a rule, the configuration information can thus be created, generated and/or adapted in a data set and/or configuration data set. The configuration information represents the information relating to the language to be used, national standards, specifications, the control center used for the risk detection system, the risk detection system used etc. and is defined depending on the data set and/or configuration data set. This cascade-like creation of a configuration data set allows a complex, cost-effective maintenance of several configuration data sets existing in parallel to be prevented. A further advantage is that the configuration possibilities being restricted during the creation of a data set and/or a configuration data set such that only that configuration information must be adjusted which is also needed in the relevant country in the relevant risk detection control center. The degrees of freedom of the possible configuration information are thus restricted by the first data set via the second data set to the configuration data set. The data set and/or the configuration data set can be a table, a database etc. It should still be noted that it is naturally also possible for only two steps, in other words a first data set and a configuration data set, or more than three steps to be possible for creating the configuration data set in accordance with the following disclosure.

A further advantage is that the method and/or the system allow the risk for faulty configurations to be considerably reduced.

### BRIEF DESCRIPTION OF THE DRAWINGS

These and other objects and advantages will become more apparent and more readily appreciated from the following description of an exemplary embodiment, taken in conjunction with the accompanying drawings of which:

FIG. 1 is an explanatory diagram providing an example of the creation of a configuration data set,

FIG. 2 is a block diagram of a system for creating a configuration data set in accordance herewith.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

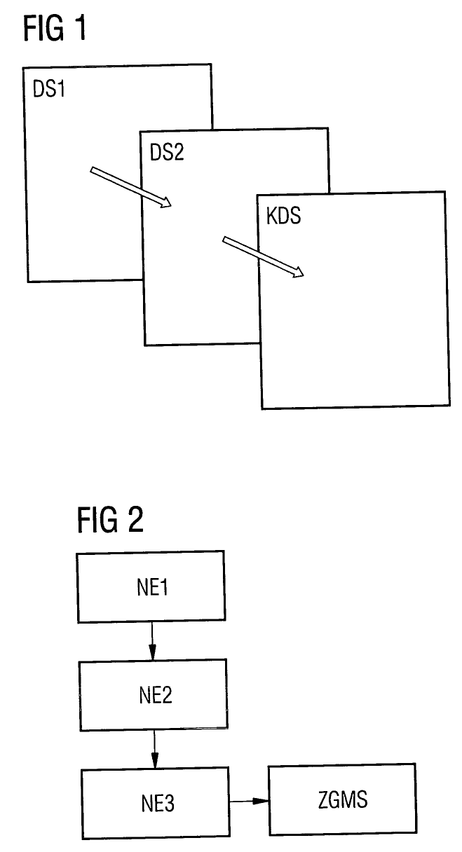

FIG. 1 shows an example of the creation of a configuration data set. To this end, a first data set DS1 containing at least one item of configuration information for a region of the world for instance (Asia, Africa, America, South America, Australia, Europe etc.) is first created using at least one first rule. A second data set DS2 is created as a function of this first data set DS1 using at least one second rule. For instance, the configuration information relating to one region of the world from the first data set DS1 can be restricted with the aid of at least one second rule such that the configuration information is restricted for a country and its standards, specifications, languages etc. The degrees of freedom of the possible configuration information are thus restricted for instance from data set DS1 to data set DS2. As a function of this second data set DS2, the configuration data set KDS can be created using at least one third rule. The configuration data set and/or the configuration information could again be restricted for instance to customer-specific and/or device-specific demand. Further rules for creating a configuration data set are naturally conceivable. Preferably, no limits are set for this purpose. The configuration data set can finally be used to configure the risk detection system to be configured and/or the control center of the risk detection system ZGMS.

FIG. 2 shows a system for creating a configuration data set in an exemplary embodiment. To this end, it is possible for instance to create the first data set DS1 in the first unit NE1 and to forward the data set DS1 to the second unit NE2. The second data set DS2 is created there with the aid of the first data set DS1 and is routed to the third unit NE3. The third unit NE3 creates the configuration data set KDS as a function of the second data set DS2 and the control center of the risk detection system ZGMS is thus configured. The units NE1, NE2, NE3 can here be connected to one another via a communication network, like for instance an IP network, a fixed network, a cellular mobile radio network etc. It would naturally also be possible for the first data set DS1, the second data set DS2 and the configuration data set KDS to be buffered prior to the respective forwarding to the unit NE1, NE2 and/or NE3 with a storage device provided therefor. Any kind of memory in a computer, mobile computer, mobile radio device etc. can be used as a storage unit. Storage media such as a CD-ROM, floppy disc etc. could also serve as a memory for instance.

The disclosure includes particular reference to preferred embodiments and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. A method for configuring a control center in a risk detection system with a configuration data set containing at least one item of configuration information, comprising:
creating a first data set containing at least one first item of configuration information is created as a function of at least one first rule;
creating a second data set containing at least one second item of configuration information as a function of the first data set and with at least one second rule;
creating a configuration data set containing at least one third item of configuration information as a function of the second data set and at least one third rule; and
configuring the control center in the risk detection system using the configuration data set.

11. A method according to claim 10, wherein at least one of the at least one first, second and third rules include a rule that is a function of the control center of the risk detection system to be configured.

12. A method according to claim 11, wherein the configuration information created includes an item of information relating to at least one of a language to be used, national standards, specifications and the control center of the risk detection system.

13. A method according to claim 12, wherein the at least one first item of configuration information in the first data set is generated in accordance with the at least one first rule for a region of the world in which the control center of the risk detection system is to be configured.

14. A method according to claim 13, wherein the at least one second item of configuration information in the second data set is generated in accordance with the at least one second rule for a country in which the control center of the risk detection system is to be configured.

15. A method according to claim 14, wherein the at least one third item of configuration information in the configuration data set is generated in accordance with the at least one third rule for use in the control center of the risk detection system.

16. A method according to claim 15, wherein at least one of the at least one first, second and third rules restricts configuration possibilities in said creating of at least one of the first, second and configuration data sets.

17. A method according to claim 16, wherein the at least one first, second and configuration data sets are at least one of a table and a database.

18. A system for configuring a control center in a risk detection system with a configuration data set containing at least one item of configuration information, comprising:
a first unit creating a first data set containing at least one first item of configuration data as a function of at least one first rule;
a second unit creating a second data set containing at least one second item of configuration information as a function of the first data set and at least one second rule;
a third unit creating a configuration data set containing at least one third item of configuration information; and
a configuration unit using the configuration data set to configure the control center in the risk detection system as a function of the second data set and at least one third rule.
